(19) United States
(12) Patent Application Publication
(10) Pub. No.: US 2016/0156466 A1
(43) Pub. Date: Jun. 2, 2016

(54) SYSTEM AND METHOD FOR QUANTUM KEY DISTRIBUTION OVER LARGE DISTANCES

(71) Applicants: Brian KIRBY, Baltimore, MD (US); James FRANSON, Ellicott City, MD (US); Garrett HICKMAN, Halethorpe, MD (US); Todd PITTMAN, Ellicott City, MD (US)

(72) Inventors: Brian KIRBY, Baltimore, MD (US); James FRANSON, Ellicott City, MD (US); Garrett HICKMAN, Halethorpe, MD (US); Todd PITTMAN, Ellicott City, MD (US)

(21) Appl. No.: 14/508,741

(22) Filed: Oct. 7, 2014

Related U.S. Application Data
(60) Provisional application No. 61/944,665, filed on Feb. 26, 2014.

(51) Int. Cl. H04L 9/08; H04B 10/70; H04B 10/85

(52) U.S. Cl. CPC H04L 9/0858; H04B 10/85; H04B 10/70

(57) ABSTRACT

Quantum key distribution QKD systems and methods are provided that allow for QKD over distances not previously achievable. In one embodiment, the QKD system and method utilizes state discrimination techniques. In another embodiment, the QKD system and method utilizes amplifiers and unitary transformations to extend the range over which QKD can be achieved. The QKD systems and methods of the present invention can be used to implement secure quantum communications systems.

This application claims priority to U.S. Provisional Application Ser. No. 61/944,665 filed Feb. 26, 2014, whose entire disclosure is incorporated herein by reference.

### GOVERNMENT RIGHTS

This invention was made with government support under Contract No. W31P4Q-10-1-0018 awarded by the Defense Advanced Research Projects Agency (DARPA). The government has certain rights in this invention.

### BACKGROUND OF THE INVENTION

1. Field of the Invention

The present invention relates to quantum communications and, more specifically, to quantum key distribution over large distances.

2. Background of the Related Art

The Background of the Related Art and the Detailed Description of Preferred Embodiments below cite numerous technical references, which are listed in the Appendix below. The numbers shown in brackets (“[ ]”) refer to specific references listed in the Appendix. For example, “[1]” refers to reference “1” in the Appendix below. All of the references listed in the Appendix below are incorporated by reference herein in their entirety.

Quantum key distribution (QKD) is the most developed application of quantum information, and is the process of using quantum communication to establish a shared key between two parties (usually called “Alice” and “Bob”) without a third party (usually called “Eve”) learning anything about that key, even if Eve can eavesdrop on all communication between Alice and Bob. This is achieved by Alice encoding the bits of the key as quantum data and sending them to Bob.

Current applications are limited by the fact that the useful bit rate decreases exponentially as a function of increasing range due to the effects of photon loss. For example, a method based on nonlocal interference between entangled macroscopic coherent states has been shown to be limited to roughly 8 km when homodyne measurement is used to distinguish between overlapping coherent states [1]. There is a need for a system and method that will increase this range.

### SUMMARY OF THE INVENTION

An object of the invention is to solve at least the above problems and/or disadvantages and to provide at least the advantages described hereinafter.

Therefore, an object of the present invention is to provide a system and method for secure communications.

Another object of the present invention is to provide a system and method for secure communications at distances over 8 km.

Another object of the present invention is to provide a system and method for secure communications at distances up to 10,000 km.

Another object of the present invention is to provide a system and method for secure communications utilizing quantum key distribution and state discrimination techniques.

Another object of the present invention is to provide a system and method for secure communications utilizing quantum key distribution, nonlocal interferometry and unitary transformations.

Another object of the present invention is to provide a system and method for secure communications utilizing quantum key distribution, nonlocal interferometry, linear amplifiers and unitary transformations.

Another object of the present invention is to provide a system and method for secure communications utilizing quantum key distribution and nonlinear phase shifts.

Another object of the present invention is to provide a system and method for secure communications utilizing quantum key distribution and nonlinear phase-entangled coherent states.

Another object of the present invention is to provide a system and method for secure communications utilizing quantum key distribution and homodyne measurements.

Another object of the present invention is to provide a system and method for secure communications utilizing quantum key distribution and an Hermitian matrix with digital values.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 are plots showing entangled photon holes in which there is a correlated absence of photons in two distant beams of light;

FIG. 2 are plots showing a macroscopic entangled state in which two coherent states (e.g., coherent optical beams) have undergone a phase modulation at the same distance from the source;

FIG. 3A is a schematic diagram of a source of entangled macroscopic coherent states;

FIG. 3B are plots illustrating phase space representations of the two coherent states shown in FIG. 3A after interaction with the nonlinear medium;

FIG. 4 is a schematic diagram of a nonlocal interferometer implemented using phase entangled coherent states, in accordance with one preferred embodiment of the present invention;

FIG. 5A is a phase space diagram illustrating two coherent states with different phases;

FIG. 5B is a phase space diagram illustrating use of displacement operations to transform one of two partially-overlapping coherent states to the vacuum, which allows a single photon detection to distinguish between the two states;

FIG. 6 is a schematic diagram of a coherent state displacement system, in accordance with the present invention;

FIGS. 7A and 7B are schematic diagrams of a state discrimination system for determining whether or not the coherent state from a laser has undergone a net phase shift of zero, in accordance with one preferred embodiment of the present invention;

FIG. 8 is a schematic diagram of an enhanced state discrimination measurement system utilizing an enhanced state discrimination technique in which the coherent states from each of the coherent optical beams are displaced in such a way that the states with zero net phase shift are transformed into the vacuum state, in accordance with one preferred embodiment of the present invention;

FIG. 9 is a schematic diagram illustrating how distributed amplification can be used in a system in which the state in Eq. (32) is sent from one location to another, in accordance with one preferred embodiment of the present invention;

FIG. 10 is a schematic diagram illustrating how a third party can extract a fraction of each coherent state;

FIG. 11 is a schematic diagram of a system that limits the information available to a non-authorized third party by preparing M pairs (M=2 in this example) of phase-entangled coherent states and performing a linear unitary transformation which is only known to the authorized parties that are communicating with each other, in accordance with one preferred embodiment of the present invention;

FIGS. 12A and 12B are schematic diagrams of a linear unitary transformation generator used in the system of FIG. 11, in accordance with one preferred embodiment of the present invention.

### DETAILED DESCRIPTION OF PREFERRED EMBODIMENTS

The systems and methods of the present invention extend the distance over which QKD can be performed. In a first embodiment of the present invention, the distance over which QKD can be performed with a macroscopic nonlocal interferometer is extended through the use of state discrimination techniques. However, in practice the range obtained through the use of state discrimination techniques will be bound by gigabit data rates, limiting the useful range to approximately 400 km. In a second embodiment of the present invention, a reformulation of a nonlocal interferometer QKD scheme is utilized that uses linear amplifiers. Entanglement will still be a necessary resource in this new scheme, but security will no longer rely on a violation of Bell's inequality. Instead the security will be based on the difficulty an eavesdropper will experience determining a random unitary transformation known only to the sender and receiver [2].

Coherent states are the closest approximation to a classical beam of light. It is well known that a coherent state that undergoes loss in a linear medium, such as an optical fiber, will remain a coherent state but with a reduced amplitude. As a result, there is no decoherence due to photon loss and the phase of the coherent state is preserved.

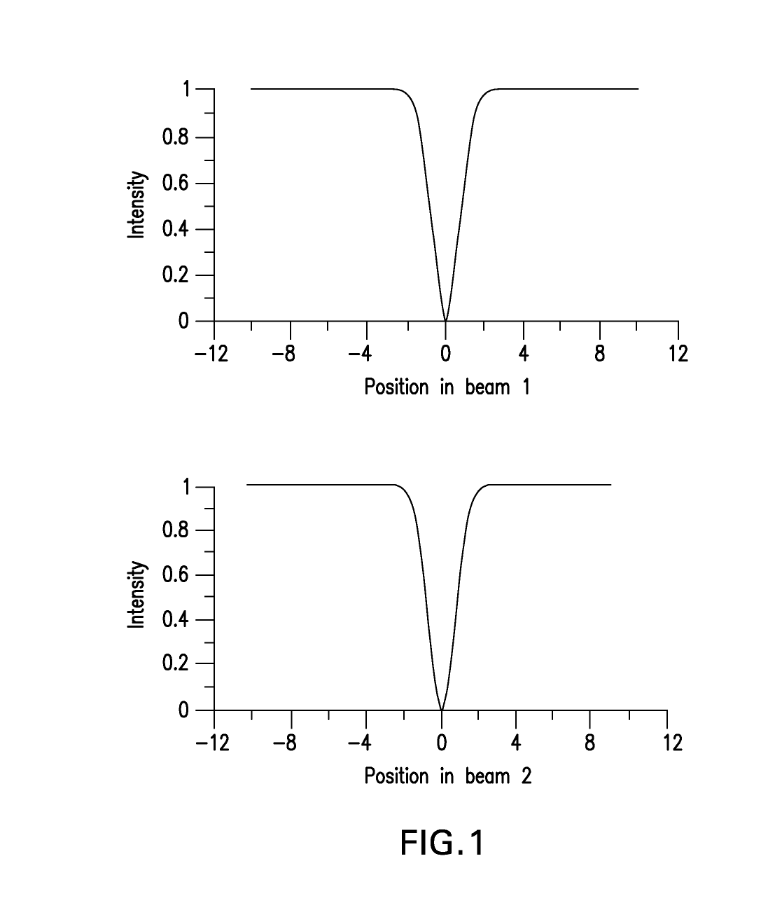

It has been shown that this property of coherent states could be used to create entangled states known as “photon holes” that are relatively insensitive to loss and amplification [3-5]. The basic idea is illustrated in FIG. 1, where two coherent state beams of light have their amplitude reduced to zero at some location to create a “hole.” The distance from the source at which the hole is carved is the same in both beams, but there is a quantum-mechanical superposition of the location at which that occurs. This corresponds to an entangled state that can be used to violate Bell's inequality and to implement a QKD system.

We previously showed that entangled photon holes are relatively insensitive to absorption and amplification, unlike other forms of macroscopic entangled states. Generally speaking, if the final state of an atom that absorbs a photon is independent of the location of the hole, then the medium does not retain any “which-path” information that would create decoherence and reduce quantum interference effects. A more detailed discussion of these effects can be found in Ref [3].

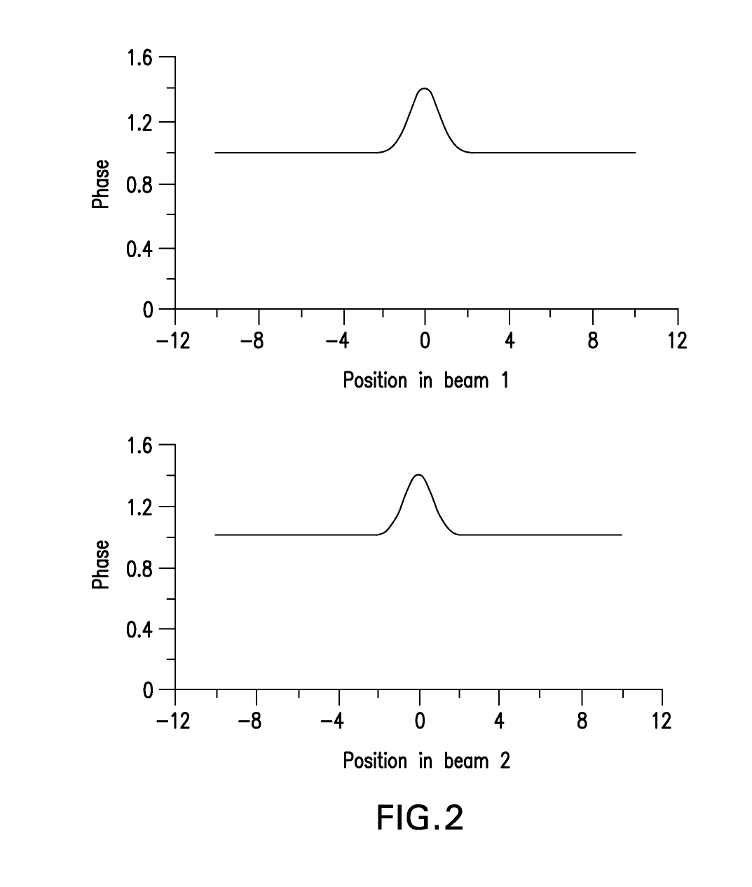

Entangled photon holes are sensitive, however, to beam splitter losses, which would limit their suitability for QKD systems under realistic conditions. This difficulty can be mitigated by using entangled states in which the phase of the two coherent states is modulated instead of their amplitude, as illustrated in FIG. 2. FIG. 2 are plots showing a macroscopic entangled state in which two coherent states (coherent optical beams) have undergone a phase modulation at the same distance from the source. A superposition of the location at which that occurs corresponds to an entangled state with properties that are similar in some respects to the entangled photon holes show in FIG. 1. This approach also has a number of other practical abriaattdvantages.

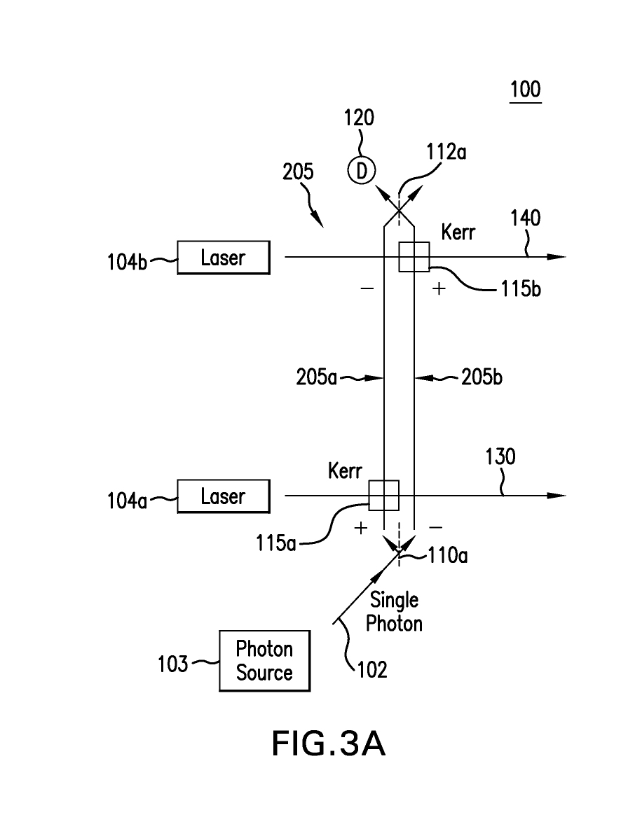

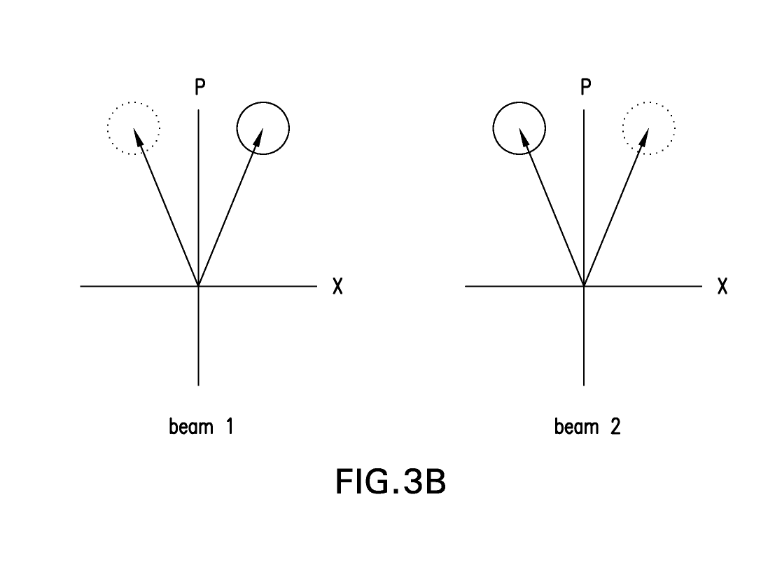

One advantage of the entangled phase states of FIG. 2 is that they can be generated using the Kerr effect, as illustrated in FIG. 3A, which is a schematic diagram of a source of entangled coherent states 100. A single photon 102 can produce a relatively large phase shift in a coherent state if the two are passed through a suitable nonlinear medium, such as a Kerr nonlinear medium. If the intensity of the coherent state is sufficiently large, the resulting state will be orthogonal to the original state, as illustrated in the phase-space diagram of FIG. 3B. It has been shown that weak nonlinearities of this kind could be used to perform quantum logic operations [6].

The source of entangled coherent states 100 pictured in FIG. 3A is implemented with a single photon interferometer 205, preferably a Mach-Zhender interferometer implemented with beam splitters 110a and 112a. Beam splitters 110a and 112a are preferably implemented with fused silica fiber beam splitters, but any other type of beam splitter known in the art may be utilized.

Beam splitter 110a splits a single photon 102 from photon source 103 into the two paths of the single photon interferometer 205. The photon source 103 is suitably a post selected weak coherent source, such as an attenuated diode laser. Kerr media 155a and 115b are positioned in each path of the single photon interferometer 205. The Kerr media 115a and 115b in each path of the single photon interferometer 205 are suitably Kerr cells, which are preferably implemented with metastable xenon in a high finesse cavity.

A first laser 104a generates coherent optical beam 130 and a second laser 104b generates coherent optical beam 140. Coherent optical beam 130 is directed through Kerr medium 115a, and coherent optical beam 140 is directed through Kerr medium 115b. Lasers 104a and 104b are suitably frequency stabilized diode lasers. Coherent optical beams 130 and 140 preferably have a wavelength of approximately 853 nm for implementations utilizing xenon in a high finesse cavity as a Kerr nonlinearity, however the 1550 nm telecom bandwidth is preferable. Coherent optical beams 130 and 140 preferably have a power of at least approximately 30 mW.

One path 205a of the single photon interferometer 205 is capable of producing a phase shift on coherent optical beam 130 and the other path 205b of the single photon interferometer 2015 is capable of producing a phase shift in coherent optical beam 140. A constant phase shift is added to both beams 130 and 140 so that the beams 130 and 140 can be viewed as having been phase shifted by a positive or negative amount depending on the path taken by the single photon 102. The constant phase shift is preferably imparted onto coherent optical beams 130 and 140 with a wave plate (not shown).

A detector 120 is used to select only those events in which the photon 102 emerges in the path of the detector 120. This creates an entangled phase state similar to that illustrated in FIG. 3B, where the phases are anti-correlated and occur at a fixed time. Specifically, FIG. 3B is a phase space representation of the two coherent states produced by the source 100 of FIG. 3A after interaction with the Kerr media 115a and 115b. The system is left in superposition of anti-correlated phase shifts with coherent optical beam 130 being shifted positively and coherent optical beam 140 being shifted negatively (solid circles), or vice versa (dashed circles).

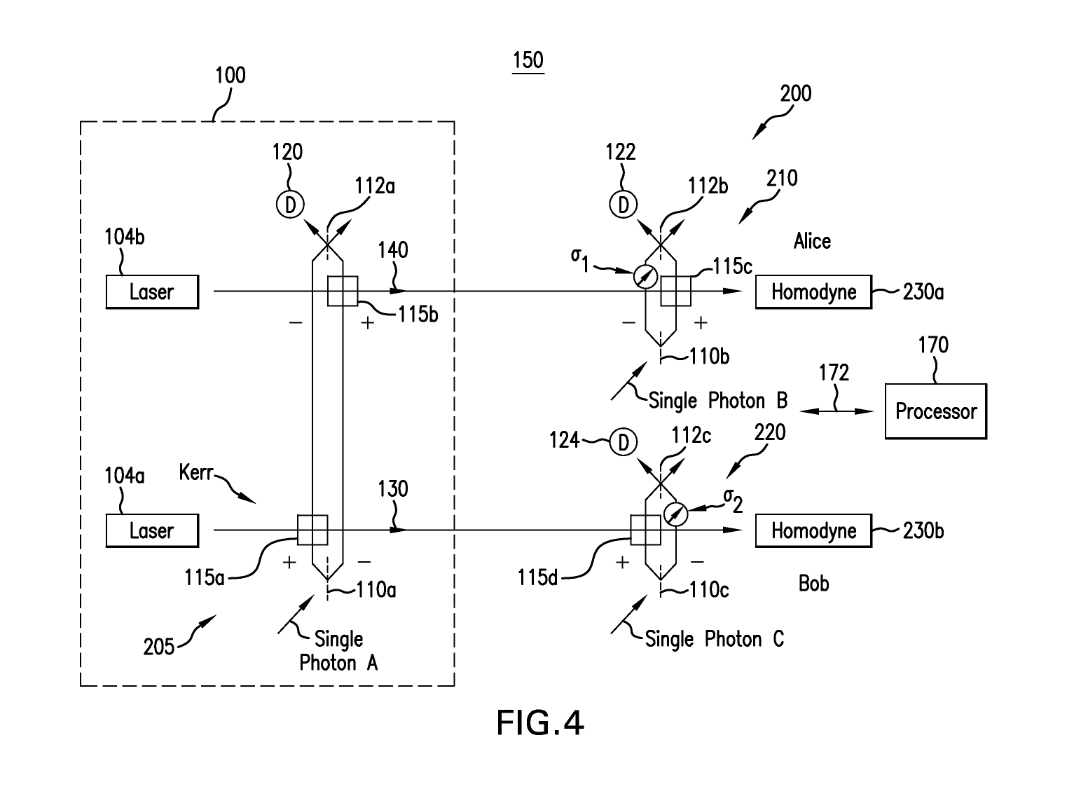

It has been shown that techniques of this kind can be used to construct a nonlocal interferometer, such as the one illustrated in FIG. 4 [1]. This approach can be viewed as a generalization of the “Franson interferometer” that one of the inventors of the present invention, Dr. J. D. Franson, has proposed and demonstrated.

FIG. 4 is a schematic diagram of a QKD system 150 implemented with a nonlocal interferometer 200 implemented using phase entangled coherent states. The letter “D” denotes a detector while the + and − signs refer to the sign of the phase shift produced at that location, assuming that a single photon took that path. Only those events in which the single-photon interferometers produce a detection event in the D detectors are accepted, and only those events in which the homodyne detectors show no net phase shift of the coherent optical beams are accepted.

The source of the phase-entangled coherent states 100 is illustrated in the left-hand side of FIG. 4 [6-12]. A single photon labeled “A” passes through a first single photon interferometer 205 containing Kerr media 115a and 115b in each path. A nonlinear phase shift of 2φ is assumed to be generated if single photon A and a coherent state are present in one of the Kerr media 115a and 115b simultaneously. A bias phase shift of −φ is added to both beams so that phase shifts of ±φ are created in each beam depending on the path taken by photon A. Post-selection on events in which a photon was observed in detector 120 ensures that there is a well-defined phase between the two terms in the superposition state |ψ [symbol] that describes the output of the source, which is given by

|ψₛ [symbol] =(|α₊)|β₋ [symbol] +|α₋ [symbol] |β₊ [symbol] )/\sqrt{2} (1)

Here |α₊ [symbol] represents a coherent state in coherent optical beam 130 with a positive phase shift while |β₋ [symbol] represents a coherent state in coherent optical beam 140 with a negative phase shift. The states |α₋ [symbol] and |β₊ [symbol] are defined in a similar way.

This entangled state can then be probed using two distant single photon interferometers 210 and 220, which are preferably Mach-Zehnder interferometers, as illustrated in the right-hand side of FIG. 4. Both single photon interferometers 210 and 220 have respective Kerr media 115c and 115d placed in one of the two paths, which again produces a phase shift of 2φ if both a coherent state and a single photon are present in the same path. Bias phase shifts of −φ are added once again so that a net phase shift of ±φ is produced depending on the path taken by the single photons, as before. In addition, fixed (linear) phase shifts σ₁ and σ₂ are included in one of the two paths of each single photon interferometer 210 and 220 as shown FIG. 4. The phase shifts σ₁ and σ₂ are preferably imparted using a lithium niobate waveguide (not shown).

Homodyne measurements are then made with homodyne detectors 230a and 230b, which are used to determine the final phases of the coherent states after they have passed through both sets of single photon interferometers 210 and 220. Homodyne detectors 230a and 230b are suitably implemented with standard commercially available homodyne detectors. A processor 170 is provided that is in communication with and receives signals from detectors 120, 122, 124 and homodyne detectors 230a and 230b via connections 172. Connections 172 can be implemented with any techniques known in the art, such as wired connections or wireless connections (e.g., WiFi or Bluetooth connections). The processor 170 performs post-selection processing, in which only those events in which detectors 120, 122 and 124 were triggered, and in which both coherent states were measured by homodyne detectors 230a and 230b to have a net phase shift of zero, are accepted.

The processor 170 can be implemented with any type of processing device, such as a general purpose computer, a special purpose computer, a distributed computing platform located in a “cloud”, a server, a tablet computer, a smartphone, a programmed microprocessor or microcontroller and peripheral integrated circuit elements, ASICs or other integrated circuits, hardwired electronic or logic circuits such as discrete element circuits, programmable logic devices such as FPGA, PLD, PLA or PAL or the like. In general, any device on which a finite state machine capable of running the programs and/or applications used to implement the systems and methods described herein can be used as the processor 170.

It can be seen that an outcome of that kind can only occur if both single photons B and C took the left path or if both of them took the right path. This gives rise to quantum interference between the corresponding probability amplitudes, with a relative phase that depends on the values of phase shifts σ₁ and σ₂. This interference between the left-left and right-right probability amplitudes is analogous to the more familiar long-long and short-short interference that is responsible for the two-photon nonlocal interferometer proposed previously [13].

The state of the system after the photons have passed through the interferometers but before any measurements have been made can be written as

$$\vert Ψ 〉 = \frac{1}{{2}^{3}} [ {e}^{i {σ}_{2}} \vert {α}_{++} 〉 \vert {β}_{--} 〉 - \vert {α}_{++} 〉 \vert {β}_{- +} 〉 - {e}^{i ( {σ}_{1} + {σ}_{2} )} \vert {α}_{+ -} 〉 \vert {β}_{--} 〉 + {e}^{i {σ}_{1}} \vert {α}_{+ -} 〉 \vert {β}_{- +} 〉 - {e}^{i {σ}_{2}} \vert {α}_{- +} 〉 \vert {β}_{+ -} 〉 + \vert {α}_{- +} 〉 \vert {β}_{++} 〉 + {e}^{i ( {σ}_{1} + {σ}_{2} )} \vert {α}_{--} 〉 \vert {β}_{+ -} 〉 - {e}^{i {σ}_{1}} \vert {α}_{--} 〉 \vert {β}_{++} 〉 ] \times {\vert 1 〉}_{1} {\vert 0 〉}_{2} {\vert 1 〉}_{3} {\vert 0 〉}_{4} {\vert 1 〉}_{5} {\vert 0 〉}_{6} + \vert {ψ}_{⊥} 〉 . \qquad ( 2 )$$

Here the subscripts on the coherent state amplitudes represent the positive and negative phase shifts produced by the Kerr media and a π/2 phase shift has been added upon reflection by a beam splitter. The state of the fields in the output ports of the single-photon interferometers are designated by |1 [symbol] if a photon is present in that path and |0 [symbol] if no photons are present (the vacuum state), where i labels the output ports shown in FIG. 4. Only those terms where single photons are present at detectors 120, 122 and 124 are explicitly included in Eq. (2), with the remaining orthogonal terms contained in φ_{⊥}.

If the homodyne measurements are capable of completely distinguishing between these phase-shifted states, then the measurement process can be modeled as a projection onto the states of interest [1]. The corresponding projection for the case in which a photon was detected at detectors 120, 122 and 124 while zero net phase shifts were observed for both coherent states can be written as

|p [symbol] 1/2³[e^{iσ}^{₁}α₊₋ [symbol] |β₋₊ [symbol] −e^{iσ}^{₂}|α₋₊ [symbol] |β₊₋ [symbol] ]×|1 [symbol] ₁|0 [symbol] ₂|1 [symbol] ₃|0 [symbol] ₄|1 [symbol] ₅|0₆. (3)

The probability of such an outcome is given by

$$〈 p \vert p 〉 = \frac{1}{{2}^{6}} {\vert {e}^{{iσ}_{1}} - {e}^{{iσ}_{2}} \vert}^{2} = \frac{1}{{2}^{4}} {sin}^{2} ( \frac{{σ}_{1} - {σ}_{2}}{2} ) . \qquad ( 4 )$$

In the absence of any photon loss or measurement noise, this corresponds to an interference pattern with a visibility of 100%, which can be used to violate the CHSH form of the Bell inequality [14, 15].

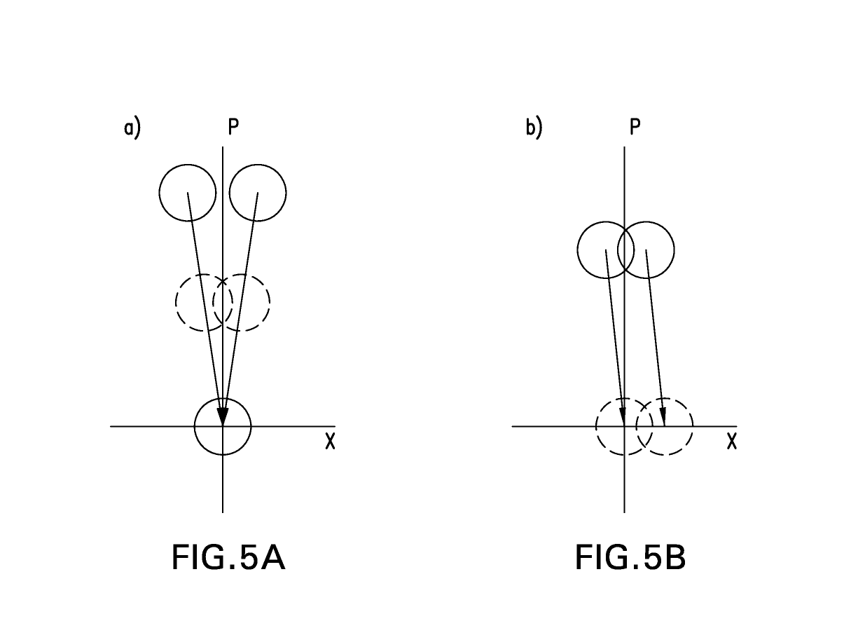

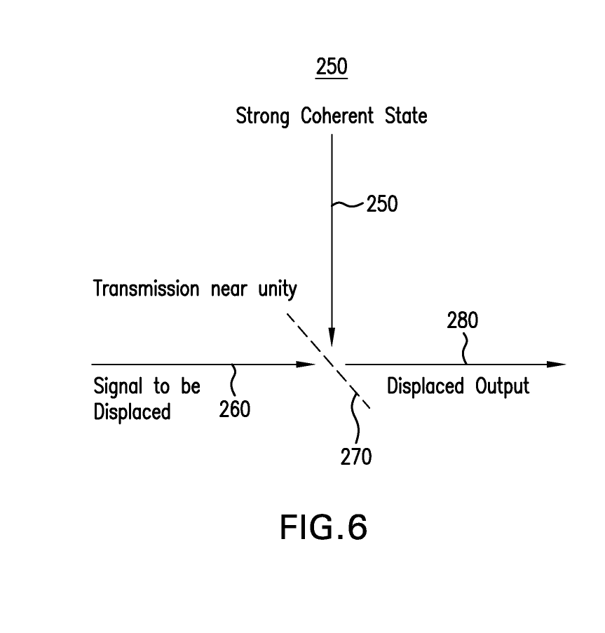

Photon loss reduces the visibility of the interference pattern for two reasons. The first problem is decoherence produced by which-path information left in the environment when a photon is absorbed or scattered out of an optical fiber. The second problem is the increasing overlap of the coherent states as their amplitudes are reduced by loss and they approach the vacuum as illustrated in FIG. 5A, which is a phase-space diagram (Wigner distributions) illustrating two coherent states with different phases. The “x” axis and the “p” axis represent the two quadratures of the field in dimensionless units. This makes it more difficult to distinguish between the various phase-shifted states.

The effects of photon loss can be included by assuming that beam splitters have been inserted into the long paths between the interferometers. First consider the effects of inserting a single beam splitter with a small reflectivity into the paths of interferometers 205 and 210. If we let |γ_{±} [symbol] and |δ_{±} [symbol] denote the coherent states in the output ports of the beam splitters in the paths of interferometers 205 and 210 respectively, then the projection |p_{L} [symbol] onto the state of interest is given by

|p_{L} [symbol] =1/2³[e^{iσ}^{₁}|α′₊₋ [symbol] |β′₋₊ [symbol] |γ₊ [symbol] |δ₋ [symbol] −e^{iσ}^{₂}|α′₋₊ [symbol] |β′₊₋ [symbol] |γ₋ [symbol] |δ₊ [symbol] ]|1 [symbol] ₁|0 [symbol] ₂|1 [symbol] ₃|0 [symbol] ₄|1 [symbol] ₅|0 [symbol] ₆ (5)

instead of by Eq. (3). Here the primes in the coherent states |α′₊₋ [symbol] , |α′₋₊ [symbol] , |β′₋₊ [symbol] , and |β′₊₋ [symbol] represent the fact that their amplitudes have been reduced by the beam splitters.

The interference cross terms in [symbol] p_{L}|p_{L} [symbol] will be reduced to the extent that there is limited overlap between the states |β₋ [symbol] and |γ₊ [symbol] , for example. As a result, it can be shown that the visibility ν of the interference pattern will be reduced to

ν=| [symbol] γ₊|γ₋ [symbol] |²=exp[−|β₊−γ₋|²]. (6)

For simplicity, it is assumed that both beams experience the same loss and the square in Eq. (6) reflects the contributions from both beam splitters. We can write |γ_{±} [symbol] in the form

|γ_{±} [symbol] =|rαe^{±iφ} [symbol] , (7)

where r is the reflectivity of the beam splitter inserted into the path to interferometer 205 and α is the initial coherent state amplitude. Then e^{±iφ} terms can be expanded in a Taylor series for small values of φ which reduces Eq. (6) to

ν=exp[−4(rαφ)²]=exp[−4N_{L}φ²]. (8)

N_{L}=(rα)² is defined as the average number of photons lost in each path.

This reduction in the visibility can be interpreted as being due to information left in the output ports of the beam splitters. The same results are obtained if a large number of beam splitters produce a total loss of N_{L} photons in each path.

The nonlocal interferometer 200 of FIG. 4 can implement the QKD system 150 in a way that decouples loss from bit rate. For example, suppose that some fraction of the pulses do not pass through the final two interferometers 210 and 220 located at Alice and Bob, respectively. Instead, a homodyne measurement determines whether or not each beam has been shifted in phase by a positive or negative amount. The results of each measurement can be assign a bit value of “0” or “1”, and those values can be used to form a secret key (after error correction and privacy amplification) because they are anti-correlated. The advantage of this approach is that the bit values themselves are carried by coherent states, which are essentially classical pulses. Thus the bit rate is not decreased by loss and the noise in the bits is essentially the same as in a conventional fiber optics communications system.

The security of the QKD system 150 can be ensured by passing the remaining fraction of the pulses through the single photon interferometers 210 and 220 located at Alice and Bob, respectively. A violation of Bell's inequality ensures that no eavesdropper has intercepted the information.

If homodyne measurements are used to measure the final phase shift of the coherent states, such as is done in the nonlocal interferometer 200 of FIG. 4, then the increasing overlap of the various phase-shifted states in the presence of loss makes it increasingly difficult to accurately distinguish between them as illustrated in FIG. 5A. This introduces errors into the measured correlations and further reduces the visibility of the interference pattern. That effect was analyzed in detail in Ref. [1], where it was found that the maximum distance over which the CHSH form of Bell's inequality can be violated is limited to roughly 8 km in optical fibers with 0.15 dB/km loss. That analysis will not be described in more detail here because the problem can be avoided by replacing the homodyne measurements with state discrimination techniques, as will be described in more detail below.

### Improved Range with Unambiguous State Discrimination

The limited range over which Bell's inequality can be violated by the nonlocal interferometer 200 of FIG. 4 is the result of photon loss. Photon loss reduces the amplitude of a coherent state, causing it to converge on the vacuum in the limit of all photons being removed. A superposition of coherent states, as pictured in FIG. 5A, will therefore begin to overlap if the loss is significant, making it difficult for homodyne measurement to successfully distinguish between them.

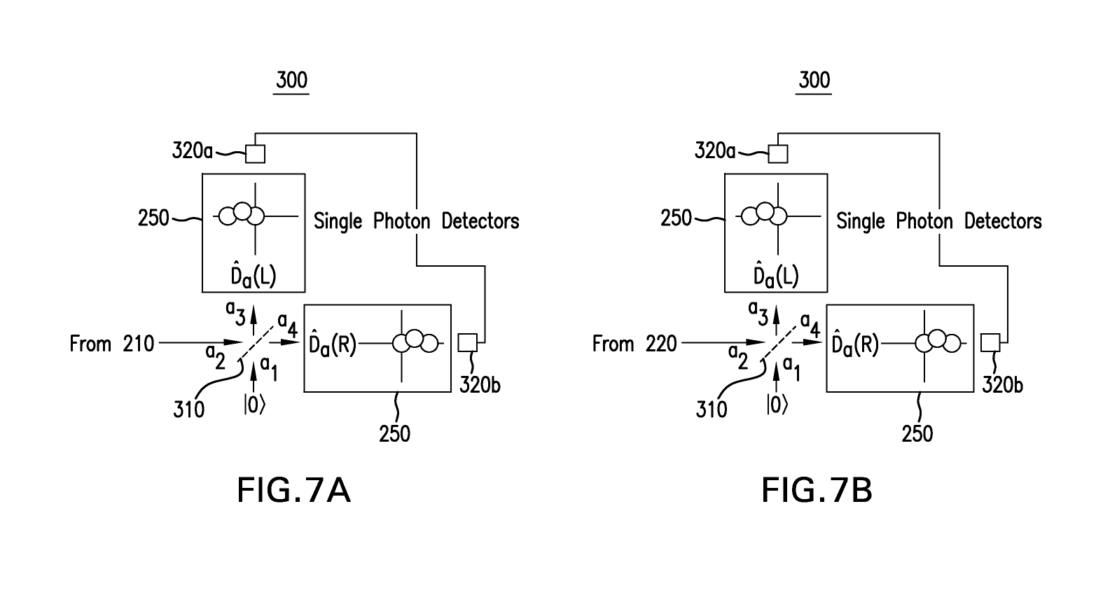

Replacing the homodyne measurements of Alice and Bob in FIG. 4 with unambiguous state discrimination techniques can significantly increase the range of the QKD system based on the nonlocal interferometer 200 of FIG. 4. A simple example of unambiguous state discrimination applied to two coherent states is pictured in FIG. 5B. In FIG. 5B, two overlapping coherent states, which are represented as solid circles, are displaced so that one of the two states becomes the vacuum. After this displacement operation, single photon detectors measure the resulting output. If a photon is detected, then the coherent state that was displaced to vacuum could not have been present. If no detection occurs, then no information is given, since any coherent state has a probability of being detected as a vacuum. Displacement operations on coherent states can be implemented by combining the coherent state of interest with an external laser at a beam splitter in the limit that the reflectivity of the beam splitter is very small, as illustrated in FIG. 6, which is a schematic diagram of a coherent state displacement system. A strong reference coherent state 250 is combined with the much weaker input coherent state 260 using a beam splitter 270 with a small reflectivity.

Once one of the coherent states has been displaced to the vacuum in this way, the detection of one or more photons at the displaced output 280 indicates that the other coherent state must have been present. Ignoring the effects of detector noise for the moment, this process allows the two coherent states to be distinguished with certainty some fraction of the time.

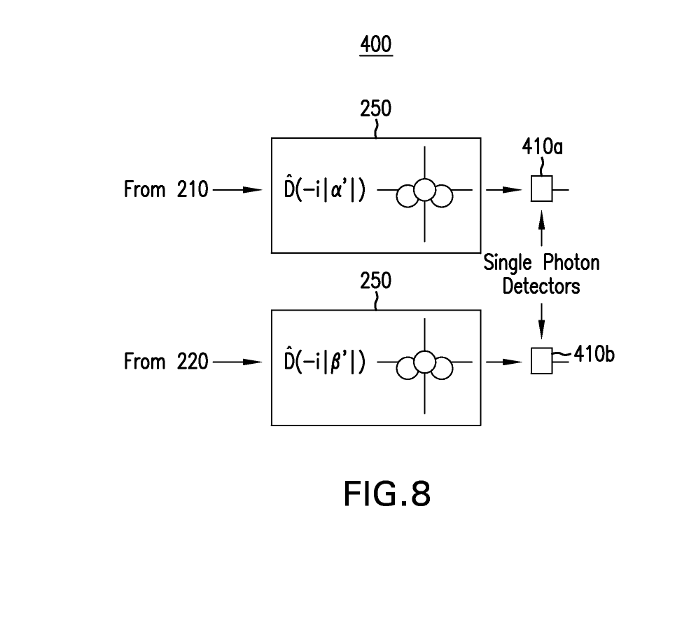

A straightforward state discrimination technique that can be used to post-select those events in which the coherent state from laser 104b has undergone a net phase shift of zero is illustrated in FIG. 7A, which is a schematic diagram of a state discrimination system 300 for determining whether or not the coherent state from laser 104b has undergone a net phase shift of zero. The state discrimination system 300 takes the place of homodyne detector 230a in FIG. 4. The interferometer 210 of FIG. 4 will have produced a net phase shift of either ±2φ or 0 depending on the paths taken by the single photons.

The coherent state at the output of interferometer 210 is first passed through a 50/50 beam splitter 310. A displacement operation is then performed on the coherent state in one of the output ports of the beam splitter 310 with displacement system 250 in such a way as to displace a state with phase shift 2φ to the vacuum. The detection of one or more photons by single photon detector 320a after that displacement operation indicates that a state with phase shift 2φ was not present. The coherent state in the other output port of the beam splitter 300 is then displaced with displacement system 250 in such a way that a state with phase shift −2φ will be displaced to the vacuum, and the detection of one or more photons there with single photon detector 320b indicates that a state with that phase was not present. Post-selection is done by processor 170 (FIG. 4) on those events where one or more photons were detected in both output ports of the beam splitter, which can only occur when the coherent state had zero net phase shift as desired.

A similar state discrimination technique is also applied to the coherent state from laser 104a using state discrimination system 300 of FIG. 7B, which takes the place of homodyne detector 230b in FIG. 4. A successful outcome for both measurements can then be used to post-select the two states shown in Eq. (3) as required for quantum interference to occur. This requires two successful detection events for the coherent state from laser 104b and two more detection events for the coherent state from laser 104a. This dependence on four-fold detection events gives a relatively low success rate when both signals have been highly attenuated by the losses in an optical fiber. A more efficient state discrimination technique will be described below, but the straightforward approach described above will first be described.

Let operator \hat{B}(λ) denote the effect of a beam splitter with reflectivity λ acting on two incident coherent states |μ [symbol] and |ν [symbol] in input ports 1 and 2, respectively [16]:

\hat{B}(λ)|μ [symbol] |ν [symbol] ₂=|\sqrt{1−λ}μ+\sqrt{λ}ν [symbol] \textcircled{x}|−\sqrt{λ}μ+\sqrt{1−λ}ν [symbol] . (9)

For the case of a vacuum state in port 1 and a 50/50 beam splitter (λ=½), this simplifies to

$$\hat{B} ( 1 / 2 ) \vert 0 〉 {\vert v 〉}_{2} = {\vert \frac{1}{\sqrt{2}} v 〉}_{3} ⊗ {\vert \frac{1}{\sqrt{2}} 〉}_{4} . \qquad ( 10 )$$

A displacement operator \hat{D}(τ) acting on a coherent state |ν [symbol] is defined by [17]

\hat{D}(τ)|ν [symbol] =|ν+τ [symbol] , (11)

where both ν and τ are in general complex numbers.

The state of the system before the measurements shown in FIG. 4 can be written as in Eq. (2), but including the loss terms |γ_{±} [symbol] and |δ_{±} [symbol] discussed in section II gives

$$\vert {Ψ}^{′} 〉 = \frac{1}{{2}^{3}} [ {e}^{i {σ}_{2}} \vert {α}_{++}^{′} 〉 \vert {β}_{--}^{′} 〉 \vert {γ}_{+} 〉 \vert {δ}_{-} 〉 - \vert {α}_{++}^{′} 〉 \vert {β}_{- +}^{′} 〉 \vert {γ}_{+} 〉 \vert {δ}_{-} 〉 - {e}^{i ( {σ}_{1} + {σ}_{2} )} \vert {α}_{+ -}^{′} 〉 \vert {β}_{--}^{′} 〉 \vert {γ}_{+} 〉 \vert {δ}_{-} 〉 + {e}^{i {σ}_{1}} \vert {α}_{+ -}^{′} 〉 \vert {β}_{- +}^{′} 〉 \vert {γ}_{+} 〉 \vert {δ}_{-} 〉 - {e}^{i {σ}_{2}} \vert {α}_{- +}^{′} 〉 \vert {β}_{+ -}^{′} 〉 \vert {γ}_{-} 〉 \vert {δ}_{+} 〉 + \vert {α}_{- +}^{′} 〉 \vert {β}_{++}^{′} 〉 \vert {γ}_{-} 〉 \vert {δ}_{+} 〉 + {e}^{i ( {σ}_{1} + {σ}_{2} )} \vert {α}_{--}^{′} 〉 \vert {β}_{++}^{′} 〉 \vert {γ}_{-} 〉 \vert {δ}_{+} 〉 ] . \qquad ( 12 )$$

Here the single photon and orthogonal terms have been dropped for convenience.

The amplitudes \tilde{α}_{±±} of the coherent states in the output ports of the beam splitter shown in FIG. 4 will correspond to the amplitudes of Eq. (12) reduced by a factor of 1/\sqrt{2}. Using exp(2iφ)=cos(2φ)+i sin(2φ) gives

$${\tilde{α}}_{+ -} = {\tilde{α}}_{- +} = i \frac{\vert {α}^{′} \vert}{\sqrt{2}} \\ {\tilde{α}}_{++} = - \frac{\vert {α}^{′} \vert}{\sqrt{2}} sin ( 2 φ ) + i \frac{\vert {α}^{′} \vert}{\sqrt{2}} cos ( 2 φ ) \\ {\tilde{α}}_{--} = \frac{\vert {α}^{′} \vert}{\sqrt{2}} sin ( 2 φ ) + i \frac{\vert {α}^{′} \vert}{\sqrt{2}} cos ( 2 φ ) . \qquad ( 13 )$$

Here we have defined α′≡α′₊₋=α′₋₊. Similar results apply to the coherent state from laser 2.

The two displacement operations shown in FIG. 4 by \hat{D}(L) and \hat{D}(R) are denoted. The desired effects of these displacement operations on the coherent states from beam 104b will be denoted as follows:

\hat{D}(L)|\tilde{α}₊₊ [symbol] =L′₊ [symbol] \hat{D}(R)|\tilde{α}₊₊ [symbol] =|0

[symbol]

\hat{D}(L)|\tilde{α}_{±∓} [symbol] =|L′₀ [symbol] \hat{D}(R)|\tilde{α}_{±∓} [symbol] =|R′₀

[symbol]

\hat{D}(L)|\tilde{α}₋₋ [symbol] =|0 [symbol] \hat{D}(R)|\tilde{α}₋₋ [symbol] =|R′₋ [symbol] . (14)

Here |L₊ [symbol] is used to denote the state of the positively phase-shifted state after the displacement operation, with a similar notation for the other states.

Combining Eqs. (11), (13), and (14) gives the required values of the displacement amplitudes L and R:

$$L = - \frac{\vert {α}^{′} \vert}{\sqrt{2}} sin ( 2 φ ) - i \frac{\vert {α}^{′} \vert}{\sqrt{2}} cos ( 2 φ ) \\ R = \frac{\vert {α}^{′} \vert}{\sqrt{2}} sin ( 2 φ ) - i \frac{\vert {α}^{′} \vert}{\sqrt{2}} cos ( 2 φ ) . \qquad ( 15 )$$

The L′₀ and R′₀ amplitudes will play an essential role in what follows. Applying Eq. (15) to the amplitudes of Eq. (13) gives their values as

$${L}_{0}^{′} = \frac{\vert {α}^{′} \vert}{\sqrt{2}} sin ( 2 φ ) + i \frac{\vert {α}^{′} \vert}{\sqrt{2}} [ 1 - cos ( 2 φ ) ] \\ {R}_{0}^{′} = \frac{\vert {α}^{′} \vert}{\sqrt{2}} sin ( 2 φ ) + i \frac{\vert {α}^{′} \vert}{\sqrt{2}} [ 1 - cos ( 2 φ ) ] . \qquad ( 16 )$$

The state of the system just before the single photon detectors can be found by applying the relevant beam splitter and displacement operators given above to the state of the system in Eq. (12). The beam splitter operators for beams 104b and 104a will be denoted \hat{B}ₐ(½) and \hat{B}_{b} (½) respectively, where the subscripts a and b refer to the output of interferometers 205 and 210. The combined result of all of the beam splitter and displacement operations is then given by

$${\hat{D}}_{{a}_{3} {b}_{3}} ( L ) {\hat{D}}_{{a}_{4} {b}_{4}} ( R ) {\hat{B}}_{a} ( 1 / 2 ) {\hat{B}}_{b} ( 1 / 2 ) \vert {Ψ}^{′} 〉 = \frac{1}{{2}^{3}} [ {e}^{i {σ}_{2}} ( {\vert {L}_{+}^{′} 〉}_{{a}_{3}} ⊗ {\vert 0 〉}_{{a}_{4}} ) ( {\vert 0 〉}_{{b}_{3}} ⊗ {\vert {R}_{-}^{′} 〉}_{{b}_{4}} ) \vert {γ}_{+} 〉 \vert {δ}_{-} 〉 - ( {\vert {L}_{+}^{′} 〉}_{{a}_{3}} ⊗ {\vert 0 〉}_{{a}_{4}} ) ( {\vert {L}_{0}^{′} 〉}_{{b}_{3}} ⊗ {\vert {R}_{0}^{′} 〉}_{{b}_{4}} ) \vert {γ}_{+} 〉 \vert {δ}_{-} 〉 - {e}^{i ( {σ}_{1} + {σ}_{2} )} ( {\vert {L}_{0}^{′} 〉}_{{a}_{3}} ⊗ {\vert {R}_{0}^{′} 〉}_{{a}_{4}} ) ( {\vert 0 〉}_{{b}_{3}} ⊗ {\vert {R}_{-}^{′} 〉}_{{b}_{4}} ) \vert {γ}_{+} 〉 \vert {δ}_{-} 〉 + {e}^{i {σ}_{1}} ( {\vert {L}_{0}^{′} 〉}_{{a}_{3}} ⊗ {\vert {R}_{0}^{′} 〉}_{{a}_{4}} ) ( {\vert {L}_{0}^{′} 〉}_{{b}_{3}} ⊗ {\vert {R}_{0}^{′} 〉}_{{b}_{4}} ) \vert {γ}_{+} 〉 \vert {δ}_{-} 〉 - {e}^{i {σ}_{2}} ( {\vert {L}_{0}^{′} 〉}_{{a}_{3}} ⊗ {\vert {R}_{0}^{′} 〉}_{{a}_{4}} ) ( {\vert {L}_{0}^{′} 〉}_{{b}_{3}} ⊗ {\vert {R}_{0}^{′} 〉}_{{b}_{4}} ) \vert {γ}_{-} 〉 \vert {δ}_{+} 〉 + ( {\vert {L}_{0}^{′} 〉}_{{a}_{3}} ⊗ {\vert {R}_{0}^{′} 〉}_{{a}_{4}} ) ( {\vert {L}_{+}^{′} 〉}_{{b}_{3}} ⊗ {\vert 0 〉}_{{b}_{4}} ) \vert {γ}_{-} 〉 \vert {δ}_{+} 〉 + {e}^{i ( {σ}_{1} + {σ}_{2} )} ( {\vert 0 〉}_{{a}_{3}} ⊗ {\vert {R}_{-}^{′} 〉}_{{a}_{4}} ) ( {\vert {L}_{0}^{′} 〉}_{{b}_{3}} ⊗ {\vert {R}_{0}^{′} 〉}_{{b}_{4}} ) \vert {γ}_{-} 〉 \vert {δ}_{+} 〉 - {e}^{i {σ}_{1}} ( {\vert 0 〉}_{{a}_{3}} ⊗ {\vert {R}_{-}^{′} 〉}_{{a}_{4}} ) ( {\vert {L}_{+}^{′} 〉}_{{b}_{3}} ⊗ {\vert 0 〉}_{{b}_{4}} ) \vert {γ}_{-} 〉 \vert {δ}_{+} 〉 ] , \qquad ( 17 )$$

where it was assumed that α=β for convenience.

The case in which the coherent states have been attenuated to the point that there is a negligible probability of detecting more than one photon in any of the single-photon detectors shown in FIGS. 7A and 7B is now considered. The projection of Eq. (17) onto a state in which there is a single photon in each of the four detectors gives

$$〈 1 , 1 , 1 , 1 \vert {\hat{D}}_{a 3 , b 3} ( L ) {\hat{D}}_{a 4 , b 4} ( R ) {\hat{B}}_{a} ( \frac{1}{2} ) {\hat{B}}_{b} ( \frac{1}{2} ) \vert {Ψ}^{′} 〉 = \frac{1}{{2}^{3}} [ {e}^{i {σ}_{1}} 〈 1 \vert {L}_{0}^{′} 〉 〈 1 \vert {R}_{0}^{′} 〉 〈 1 \vert {L}_{0}^{′} 〉 〈 1 \vert {R}_{0}^{′} \vert {γ}_{+} 〉 \vert {δ}_{-} 〉 - {e}^{i {σ}_{2}} 〈 1 \vert {L}_{0}^{′} 〉 〈 1 \vert {R}_{0}^{′} 〉 〈 1 \vert {L}_{0}^{′} 〉 〈 1 \vert {R}_{0}^{′} 〉 \vert {γ}_{-} 〉 \vert {δ}_{+} 〉 ] . \qquad ( 18 )$$

Here the state |1,1,1,1 [symbol] corresponds to having a single photon in each of the detectors while the state |1 [symbol] denotes the presence of a photon in the individual detectors.

Factoring out the common terms reduces Eq. (18) to

$$〈 1 , 1 , 1 , 1 \vert {\hat{D}}_{a 3 , b 3} ( L ) {\hat{D}}_{a 4 , b 4} ( R ) {\hat{B}}_{a} ( \frac{1}{2} ) {\hat{B}}_{b} ( \frac{1}{2} ) \vert {Ψ}^{′} 〉 = \frac{{( 〈 1 \vert {L}_{0}^{′} 〉 〈 1 \vert {R}_{0}^{′} 〉 )}^{2}}{{2}^{3}} [ {e}^{i {σ}_{1}} \vert {γ}_{+} 〉 \vert {δ}_{-} 〉 - {e}^{i {σ}_{2}} \vert {γ}_{-} 〉 \vert {δ}_{+} 〉 ] \qquad ( 19 )$$

which is similar in form to Eqs. (3) and (5). The probability Pₛ of a successful detection event is given by

$${P}_{s} = {\vert 〈 1 , 1 , 1 , 1 \vert {\hat{D}}_{{a}_{3} {b}_{3}} ( L ) {\hat{D}}_{{a}_{4} {b}_{4}} ( R ) {\hat{B}}_{a} ( \frac{1}{2} ) {\hat{B}}_{b} ( \frac{1}{2} ) \vert {Ψ}^{′} 〉 \vert}^{2} = \frac{\vert 〈 1 \vert {L}_{0}^{′} 〉 〈 1 \vert {R}_{0}^{′} 〉 \vert}{{2}^{5}} [ 1 - \vert 〈 {γ}_{+} \vert {γ}_{-} 〉 {\vert}^{2} cos ( {σ}_{1} - {σ}_{2} ) ] , \qquad ( 20 )$$

where it was assumed once again that the same loss is experienced by both beams (|γ|=|δ|). This corresponds to a visibility of ν=| [symbol] γ₊|γ₋ [symbol] |²=exp[−4N_{L}φ²] which is the same as that in Eq. (8). The factors of [symbol] 1|L₀ [symbol] and [symbol] 1|R₀ [symbol] only affect the counting rate and not the visibility. This represents a major advantage over the use of homodyne measurements, where the overlap of the coherent states in the presence of loss produces a further decrease in the visibility.

The [symbol] 1|L₀ [symbol] and [symbol] 1|R₀ [symbol] factors in Eq. (20) can be evaluated using Eq. (16), which gives

$$〈 1 \vert {L}_{0}^{′} 〉 = \frac{\vert {α}^{′} \vert}{\sqrt{2}} [ - sin ( 2 φ ) + i ( 1 - cos ( 2 φ ) ) ] {e}^{- {\vert {α}^{′} \vert}^{2} {sin}^{2} ( φ )} \\ 〈 1 \vert {R}_{0}^{′} 〉 = \frac{\vert {α}^{′} \vert}{\sqrt{2}} [ sin ( 2 φ ) + i ( 1 - cos ( 2 φ ) ) ] {e}^{- {\vert {α}^{′} \vert}^{2} {sin}^{2} ( φ )} . \qquad ( 21 )$$

Inserting this into Eq. (20) gives

$${P}_{s} = \frac{{\vert {α}^{′} \vert}^{8} {sin}^{8} ( φ ) {e}^{- 8 {\vert {α}^{′} \vert}^{2} {sin}^{2} ( φ )}}{2} [ 1 - {e}^{- 4 {N}_{L} {φ}^{2}} cos ( {σ}_{1} - {σ}_{2} ) ] . \qquad ( 22 )$$

As an example, consider the case in which α=100, φ=0.0028, there is a loss of 0.15 dB/km in the optical fibers, and a total distance of 140 km between interferometers 210 and 220 (70 km from the source to each interferometer). Then |α′| can be found from the relation |α′|²=|α|²10^{-0.15/70/10}=891.251. After the coherent states in each arm have traveled 70 km the number of photons lost in each of the beams is given by |α|²−|α′|²=9108.75=N_{L}. Inserting these values into Eq. (22) with σ₁ and σ₂ chosen to give the maximum Rₘₐₓ or minimum Rₘᵢₙ rates gives

Rₘₐₓ=1.97×10⁻⁹(α₁−α₂=π)

Rₘᵢₙ=0.28×10⁻⁹(σ₁−σ₂=0). (23)

Assuming a source that operates at a rate of 1 GHz, one can expect approximately 2 coincidence counts per second at the maximum of the interference pattern and 0.3 counts per second when at the minimum. This corresponds to a visibility of 75%, which is in agreement with Eq. (8) and above the 70.7% value needed to violate the CHSH form of Bell's inequality [14, 15].

### Enhanced State Discrimination Approach

The state discrimination approach described above has the advantage that the visibility of the interference pattern is not affected by the increased overlap between the phase-shifted coherent states due to photon loss, but the success rate is relatively low due to its dependence on the detection of a total of four photons from the displaced coherent states. An enhanced approach is now described that only requires the detection of two photons in the displaced coherent states, which substantially increases the useful range of the system.

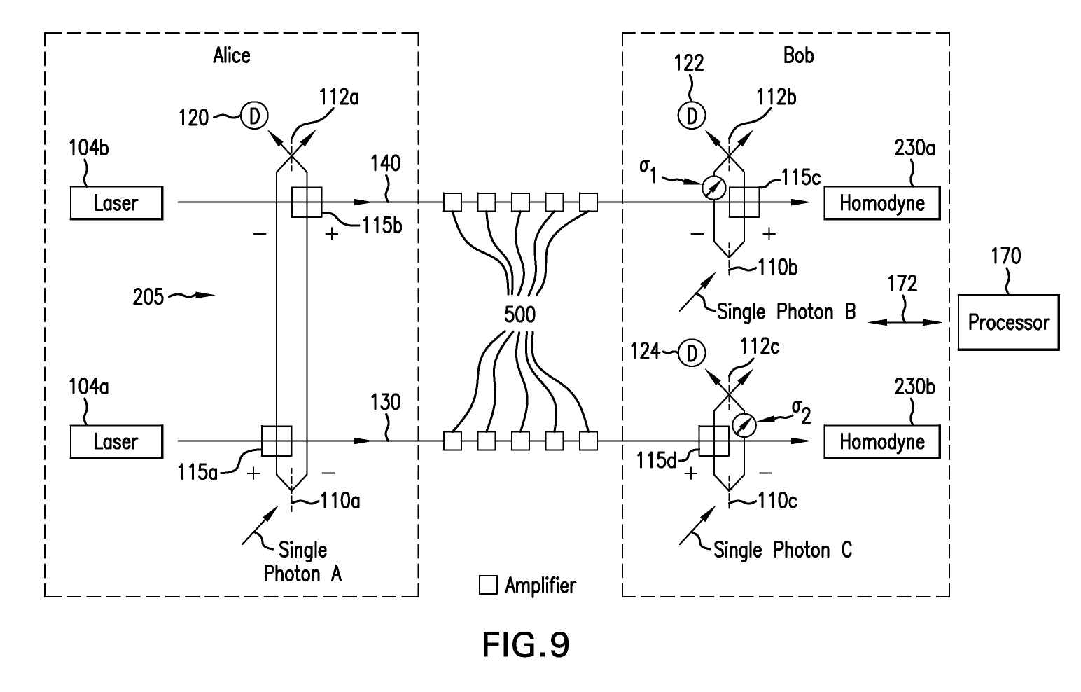

The enhanced state discrimination approach is illustrated in FIG. 8, which is a schematic diagram of an enhanced state discrimination measurement system 400 utilizing an enhanced state discrimination technique in which the coherent states from each of the coherent optical beams 104b and 104a are displaced by displacement systems 250 in such a way that the states with zero net phase shift are transformed into the vacuum state. As before, each of the two coherent states will have been shifted in phase by ±2φ or 0 and one needs to be able to distinguish between the various phase-shifted states.

The left hand side of FIG. 8 shows phase space representations of beams 104b and 104a after having passed through the nonlocal interferometers 210 and 220, respectively, (FIG. 4) but before measurement. The enhanced state discrimination measurement system 400 takes the place of homodyne detectors 230a and 230b in FIG. 4.

These coherent states are then displaced in such a way that the states with zero net phase shift are displaced to the vacuum. Single photon detectors 410a and 410b can then be used to measure the output of each displaced state. The simultaneous detection of a photon by both Alice and Bob indicates that they both must have had a state with a non-zero phase shift. Careful examination of FIG. 4 reveals that this outcome is again only possible if both photons B and C took the left path or the right path in interferometers 210 and 220, respectively.

Again, each of the coherent states is displaced in such a way that the states with zero net phase shift are displaced to the vacuum. No additional beam splitters of the kind shown in FIGS. 7A and 7B are required. A detection of one or more photons in the displaced coherent states from both laser 104b and laser 104a eliminates the probability amplitude for the terms in Eq. (12) that correspond to zero net phase shift. The only two terms that remain in the post-selected state now involve |α₊₊ [symbol] |β₋₋ [symbol] and |α₋₋ [symbol] |β₊₊ [symbol] , whereas the original approach involved |β₊₋ [symbol] |β₋₊ [symbol] and |α₋₊ [symbol] |β₊₋ [symbol] instead. Quantum interference between the corresponding probability amplitudes can once again violate the CSHS form of Bell's inequality, as described in more detail below.

The amplitudes of the three possible coherent states from laser 104b before the displacement operations are a factor of \sqrt{2} larger than those given by Eq. (13) due to the absence of the beam splitter 300 (in FIG. 7) in this enhanced approach. It can be seen that the displacement operation needed to transform the state with zero net phase shift into the vacuum state is given by \hat{D}(−i|α′|). The effect of this displacement on the states produced by laser 104b is then

\hat{D}(−i|α′|)|α′ [symbol] =|0

[symbol]

\hat{D}(−i|α′|)|α′₋₋ [symbol] =∥α′| sin(2φ)+i|α′|(cos(2φ)−1) [symbol] =|α′_{D-}

[symbol]

\hat{D}(−i|α′|)|α′₊₊ [symbol] =|−|α′| sin(2φ)+i|α′|(cos(2φ)−1) [symbol] =|α′_{D+} [symbol] (24)

with similar results for beam 104a.

Applying these displacement operators to both beams 104b and 104a in Eq. (12) results in

$${\hat{D}}_{1} ( - i \vert {α}^{′} \vert ) {\hat{D}}_{2} ( - i \vert {β}^{′} \vert ) \vert {Ψ}^{′} 〉 = \frac{1}{{2}^{3}} [ {e}^{i {σ}_{2}} \vert {α}_{D +}^{′} 〉 \vert {β}_{D -}^{′} 〉 \vert {γ}_{+} 〉 \vert {δ}_{-} 〉 - \vert {α}_{D +}^{′} 〉 \vert 0 〉 \vert {γ}_{+} 〉 \vert {δ}_{-} 〉 - {e}^{i ( {σ}_{1} + {σ}_{2} )} \vert 0 〉 \vert {β}_{D -}^{′} 〉 \vert {γ}_{+} 〉 \vert {δ}_{-} 〉 + {e}^{i {σ}_{1}} \vert 0 〉 \vert 0 〉 \vert {γ}_{+} 〉 \vert {δ}_{-} 〉 - {e}^{i {σ}_{2}} \vert 0 〉 \vert 0 〉 \vert {γ}_{-} 〉 \vert {δ}_{+} 〉 + \vert 0 〉 {β}_{D +}^{′} 〉 \vert {γ}_{-} 〉 \vert {δ}_{+} 〉 + {e}^{i ( {σ}_{1} + {σ}_{2} )} \vert {α}_{D -}^{′} 〉 \vert 0 〉 \vert {γ}_{-} 〉 \vert {δ}_{+} 〉 - {e}^{i {σ}_{1}} \vert {α}_{D -}^{′} 〉 \vert {β}_{D +}^{′} 〉 \vert {γ}_{-} 〉 \vert {δ}_{+} 〉 ] . \qquad ( 25 )$$

Here the displaced states |α_{D±} [symbol] and |β_{D±} [symbol] have been defined as indicated in Eq. (24). The probability of detecting a single photon in both beam 1 and beam 2 after the displacements shown in FIG. 8 can be found by projecting Eq. (25) onto single photon states, where we have assumed once again that the coherent states are sufficiently weak that we can neglect the probability of there being more than one photon in either detector. This gives

$$〈 1 , 1 \vert {\hat{D}}_{1} ( - i \vert α \vert ) {\hat{D}}_{2} ( - i \vert {β}^{′} \vert ) \vert {Ψ}^{′} 〉 = \frac{1}{{2}^{3}} [ {e}^{i {σ}_{2}} 〈 1 \vert {α}_{D +}^{′} 〉 〈 1 \vert {β}_{D -}^{′} 〉 \vert {γ}_{+} 〉 \vert δ 〉 - {e}^{i {σ}_{1}} 〈 1 \vert {α}_{D -}^{′} 〉 〈 1 \vert {β}_{D +}^{′} 〉 \vert {γ}_{-} 〉 \vert {δ}_{+} 〉 ] , \qquad ( 26 )$$

where the notation is analogous to that in Eq. (18).

The detection probability P_{D} is then given by

$${P}_{D} = {\vert 〈 1 , 1 \vert {\hat{D}}_{1} ( - i \vert {α}^{′} \vert ) {\hat{D}}_{2} ( - i \vert {β}^{′} \vert ) \vert Ψ 〉 \vert}^{2} = \frac{1}{{2}^{6}} [ 〈 {α}_{D +}^{′} \vert 1 〉 〈 1 \vert {α}_{D +}^{′} 〉 〈 {β}_{D -}^{′} \vert 1 〉 〈 1 \vert {β}_{D -}^{′} 〉 + 〈 {α}_{D -}^{′} \vert 1 〉 〈 1 {α}_{D -}^{′} 〉 〈 {β}_{D +}^{′} \vert 1 〉 〈 1 \vert {β}_{D +}^{′} 〉 - {e}^{- i ( {σ}_{1} - {σ}_{2} )} 〈 1 \vert {α}_{D +}^{′} 〉 〈 1 \vert {β}_{D -}^{′} 〉 〈 {α}_{D -}^{′} \vert 1 〉 〈 {β}_{D +}^{′} \vert 1 〉 〈 {γ}_{-} \vert {γ}_{+} 〉 〈 {δ}_{+} \vert {δ}_{-} 〉 - {e}^{i ( {σ}_{1} - {σ}_{2} )} 〈 {α}_{D +}^{′} \vert 1 〉 〈 {β}_{D -}^{′} \vert 1 〉 〈 1 \vert {α}_{D -}^{′} 〉 〈 1 \vert {β}_{D +}^{′} 〉 〈 {γ}_{+} \vert {γ}_{-} 〉 〈 {δ}_{-} \vert {δ}_{+} 〉 ] . \qquad ( 27 )$$

Assuming once again that both lasers have the same initial amplitude (α=β) and experience the same loss (γ=δ), this reduces to

$${P}_{D} = \frac{\vert 〈 1 \vert {α}_{D +}^{′} 〉 {\vert}^{2} \vert {〈 1 \vert {α}_{D -}^{′} 〉 \vert}^{2}}{{2}^{5}} [ 1 - \vert {〈 {γ}_{-} \vert {γ}_{+} 〉 \vert}^{2} cos ( {σ}_{1} - {σ}_{2} ) ] \qquad ( 28 )$$

The amplitudes α′_{D+} and α_{D-}′ are displaced by equal amounts so that | [symbol] 1|α′_{D+})|²=| [symbol] 1|α′_{D-} [symbol] |². The single-photon term in the usual expression for a coherent states gives

| [symbol] 1|α′_{D-} [symbol] |²=4|α′|² sin²(φ)e^{-4|α′|}^{²}^{sin}^{²}^{(φ)}. (29)

This can be inserted into Eq. (28) to give

$$\begin{matrix}{P}_{D} = \frac{\vert 〈 1 \vert {α}_{D -}^{′} 〉 {\vert}^{4}}{{2}^{5}} [ 1 - \vert 〈 {γ}_{-} {\vert {y}^{+} 〉}^{2} cos ( {σ}_{1} - {σ}_{2} ) ] \\ = \frac{{\vert {α}^{′} \vert}^{4} {sin}^{4} ( φ ) {e}^{- 8 {\vert {α}^{′} \vert}^{2} {sin}^{2} ( φ )}}{2} [ 1 - {e}^{- 4 {N}_{L} {φ}^{2}} cos ( {σ}_{1} - {σ}_{2} ) ] .\end{matrix} \qquad ( 30 )$$

It can be seen that the visibility of the interference pattern from this approach is the same as that from the previous approach as given in Eq. (8). But the success rate is proportional to |α′φ|⁴ rather than |α′φ|⁸, which is a considerable improvement given that |α′φ| is typically much less than 1. As an example, consider a situation in which α=100, φ=0.0028, a loss of 0.15 dB/km in optical fiber, and a total separation of 400 km between interferometers 210 and 220. Then |α′| can be found using |α′|²=|α|²10^{-0.15200/10}=10. After the coherent states in each path have propagated 200 km, the number of photons lost in each beam is |α|²−|α′|²=9990=N_{L}. Inserting these values into Eq. (30) gives maximum and minimum coincidence rates of

Rₘₐₓ=5.3×10⁻⁹(σ₁−σ₂=π)

Rₘᵢₙ=0.83×10⁻⁹(σ₁−σ₂=0). (31)

A source operating at a rate of 1 GHz would thus produce 5.3 coincidence counts per second when the phase shifts σ₁ and σ₂ are set to give a maximum and 0.8 counts per second when set to give a minimum. This corresponds to a visibility of ν=exp[−4N_{L}φ²] 73%, which is above the 70.7% value needed to violate the CHSH form of Bell's inequality [14, 15].

This enhanced state discrimination technique essentially doubles the range over which the same coincidence counting rate can be obtained as compared to the state discrimination approach described above. In both cases, the range over which Bell's inequality can be violated in is limited only by the desired coincidence rate, which must be sufficiently large compared to the accidental rate in the detectors. The accidental coincidence counting rate due to dark counts is negligible for most single-photon detectors compared to the rates expected from the example considered above. Detector dark counts as low as 0.0008 counts/s have been observed in silicon avalanche photodiodes, for example, with an even lower rate of accidental coincidences [18].

### Approach Utilizing Amplifiers and Unitary Transformations

As discussed above, photon loss ultimately limits the useful range over which entangled macroscopic coherent state interferometry can be used for QKD. This suggests that amplification could be used to extend the useful range by countering the effects of photon loss. The application of amplification to quantum systems is nontrivial since amplification is accompanied by noise. Therefore the use of amplification will require a reformulation of the interferometer 200 of FIG. 4. This embodiment will still require entanglement, but no longer rely on a measurement of Bell's inequality for security. Instead security will be based on the difficulty of an eavesdropper in determining a random unitary transformation known only to Alice and Bob [2].

As in the original QKD scheme, a source of entangled coherent states, such as the source 100 illustrated in FIG. 3A, is used to create the superposition state

|ψ_{±} [symbol] =(|α₊ [symbol] |β₋ [symbol] ±|α₋ [symbol] |β₊ [symbol] )/\sqrt{2}, (32)

where the |α [symbol] and |β [symbol] represent the coherent state amplitudes of lasers 104b and 104a respectively. The subscripts represent whether the coherent state was positively or negatively phase shifted by the Kerr medium. Instead of one beam going to each Alice and Bob as shown in FIG. 4, Alice creates the state of Eq. (32) herself and sends both beams to Bob. This turns out to be a key feature of this approach.

In this embodiment, the bit information is no longer encoded in the phase shift of two entangled coherent states. Instead the bit value is determined by the phase angle between the superposition of coherent states. Therefore the bit value of Eq. (32) is stored in the ± where the + and − can be assigned to “1” and “0” respectively. The use of this phase angle as a bit value means that the bit is totally entanglement dependent, and can be measured using a two-photon interferometer setup analogous to interferometers 210 and 220 in FIG. 4.

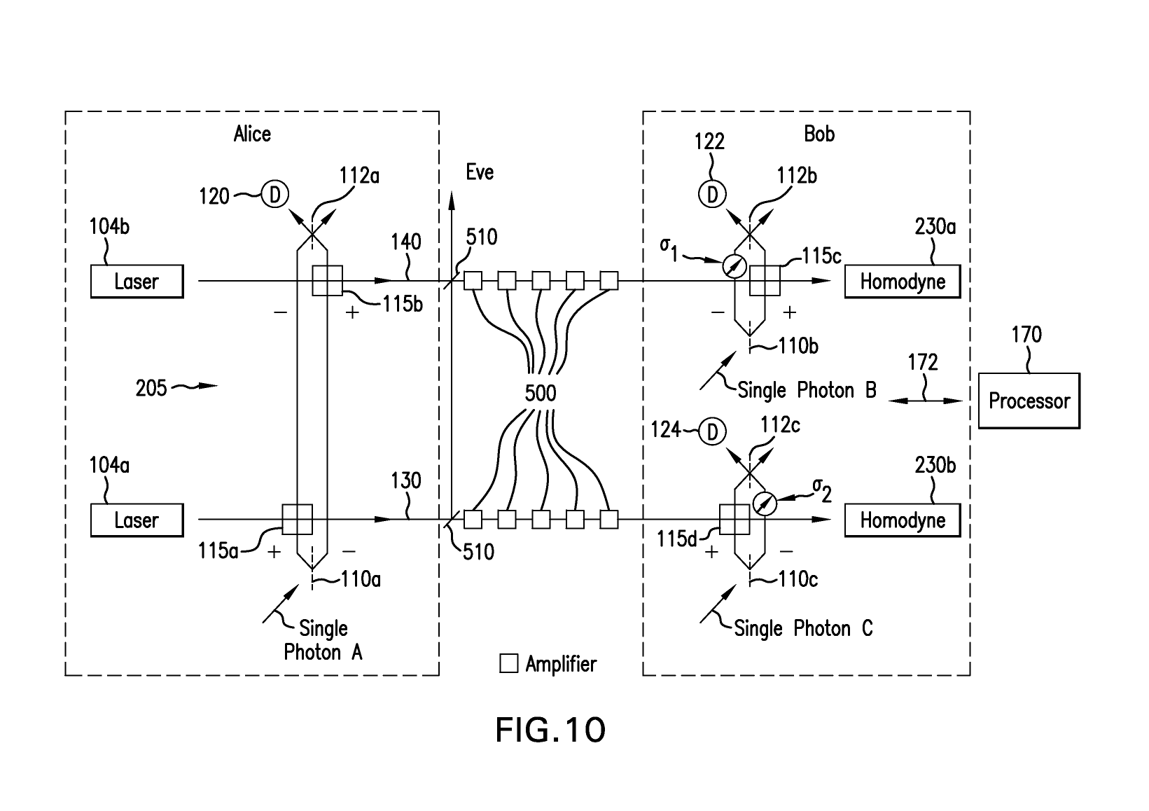

Distributed amplification can now be introduced into this scheme to extend the range to approximately 10,000 km. The basic setup is shown in FIG. 9, which is a schematic diagram illustrating how distributed amplification can be used in a system in which Alice sends the state in Eq. (32) to Bob. In the channels between Alice and Bob, distributed amplifiers 500 are used to increase the distance the signal can travel. The system shown in FIG. 9 is similar to the system 150 of FIG. 4, except amplifiers 500 are used to amplify the coherent optical beams 130 and 140. The number of amplifiers 500 shown in FIG. 9 are for illustrative purposes. Any number of amplifiers 500 may be used while still falling within the scope of the present invention. Further, the amplifiers 500 are preferably implemented with erbium doped fiber amplifiers.

It is well known that the noise associated with amplifiers in this configuration only increases linearly with distance. Therefore there is no exponential decrease in the signal to noise ratio. To compensate for the noise, Alice can repeatedly send the same bit value N=1/L² times. Bob can average the results of all of these measurements and use error correction to obtain the bit value with negligible error. The necessity of averaging in this embodiment is one reason why Alice must send both beams to Bob. Bob must be able to perform the averaging locally, meaning he must have both beams; otherwise classical information transfer would be required.

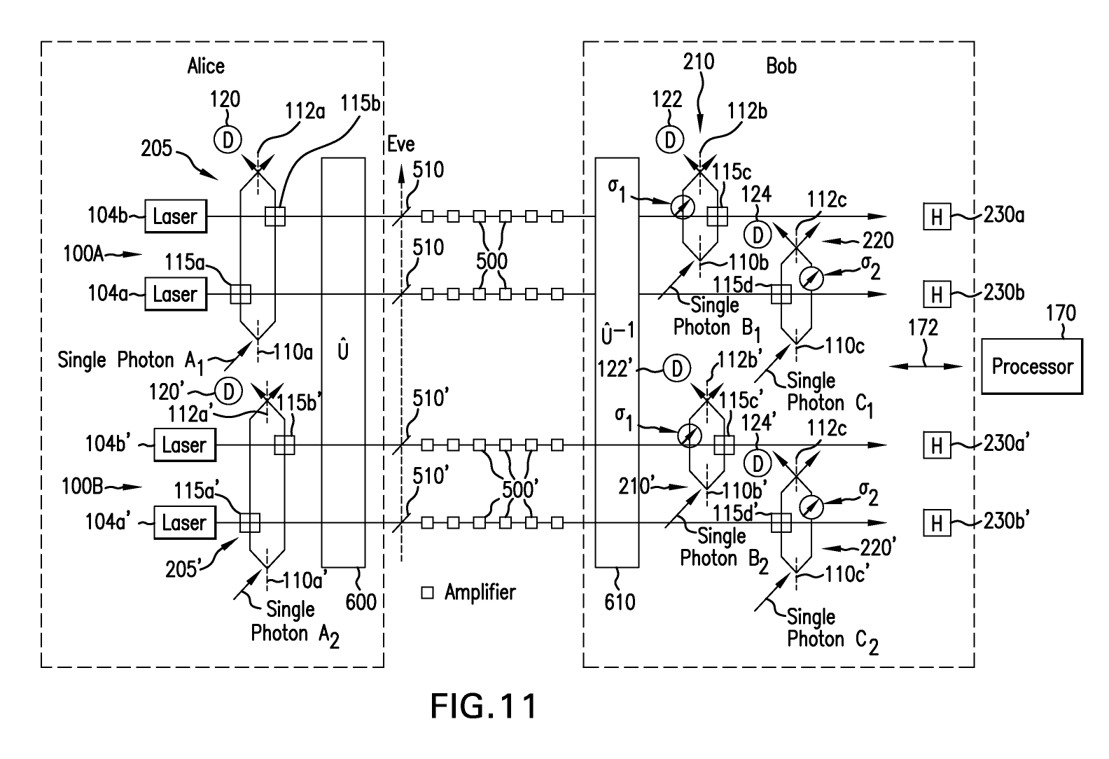

The setup shown in FIG. 9 is not secure in its present form. This is illustrated in FIG. 10, which shows where a third party (e.g., “Eve”) can extract a small fraction of each coherent state using beam splitters 510. Since Eve could make the extraction nearer to Alice than Bob, she would have a signal with less noise than Bob, making it easier for her to determine the bit value than Bob.

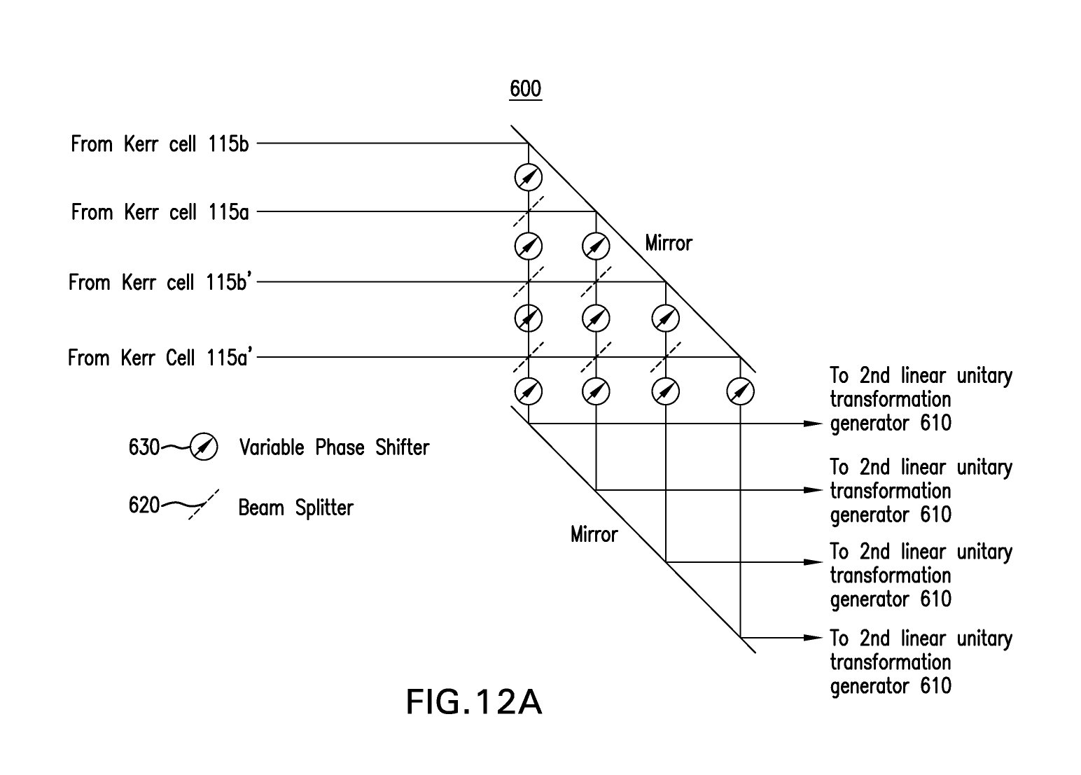

In order to counter this sort of attack from Eve, the amount of information that Eve has access to needs to be reduced. To do this Alice, prepares M pairs of phase-entangled coherent states and passes them through a linear unitary transformation Û before sending them to Bob, as illustrated in system shown in FIG. 11. For illustrative purposes, the system shown in FIG. 11 utilizes two pairs of phase entangled coherent states (M=2), however any number of pairs of phase entangled coherent states may be used while still falling within the scope of the present invention. The pair of entangled coherent states are generated using two phase-entangled coherent state sources 100A and 100B, which operate in the same manner as the phase-entangled coherent source shown in FIGS. 3A, 4 and 9.

At Bob's location, there are nonlocal single photon interferometers 210 and 220 that receive the amplified phase-entangled coherent states from phase-entangled coherent state source 100A. Similarly, there are nonlocal single photon interferometers 210′ and 220′ at Bob's location that receive the amplified phase-entangled coherent states from phase-entangled coherent state source 100B. Essentially, the system shown in FIG. 10 is reproduced M times (in this case M=2). Elements in the second system with the same functionality as corresponding elements in the first system are labeled with the same element number along with a prime symbol (′). For example, the lasers in the first system are labeled 104b and 104a, while the lasers in the second system are labeled 104b′ and 104a′. Similarly, the single photon interferometers associated with the first system at Bob's location are labeled 210 and 220, while the single photon interferometers associated with the second system at Bob's location are labeled 210′ and 220′.

As discussed above, the phase-entangled coherent states are passed through a linear unitary transformation generator 600 for generating unitary linear transformation U before sending them to Bob. By assuming that Û is pre-shared between Alice and Bob, Bob can simply apply the inverse transformation Û⁻¹ using another linear unitary transformation generator 610 to regain the original set of M pairs of phase-entangled coherent states created by Alice and perform averaging to determine the bit value.

To simplify the analysis of this embodiment, we can assume that the unitary transformation Û is given by Û=exp[−iĤ] where Ĥ is a 2M×2M Hermitian matrix with random values of ±1. For example Ĥ could be given by:

$$\hat{H =} ( \begin{matrix}+ & - & + & + & ⋯ \\ - & - & + & - & ⋯ \\ + & + & - & + & ⋯ \\ + & - & + & - & ⋯ \\ ⋯ & & & & \end{matrix} ) \qquad ( 33 )$$

The security of the system then depends on how long it takes Eve on average to determine the parameters in Ĥ.

The mutual information between Alice and Eve is very small unless Eve has guessed most of the ± signs in Eq. (33) correctly. This suggests that Eve must try on the order of 2^{4M}^{²} combinations of the signs in order to gain significant information. If Alice and Bob use a fraction of bits from previous messages to refresh Ĥ and Û then they can change the key long before Eve has a chance to try a significant number of combinations.

The security of the system depends on the assumed exponential difficulty in Eve estimating the parameter Ĥ. To illustrate this, suppose that we instead used a prepare and send protocol without entanglement and sent the bit information encoded as |α₊ [symbol] and |α₋ [symbol] as opposed to the phase angle of Eq. (32). Eve would then know the basis for the measurements and could estimate the parameters using a linear estimation technique. This would require only roughly 4M² attempts. Another advantage to storing the bit information in the entangled phase of the coherent states is that the entangled information cannot be copied and tested repeatedly as it could be classically, where an unlimited number of attempts at decrypting an intercepted message are possible. Ultimately this means that the security is not just a question of limited computational power, but instead a result of the underlying physics.

Although the systems shown in FIGS. 9, 10 and 11 utilize homodyne detectors 230a, 230b, 230a′, 230b′, the state discrimination systems 300 and 400 shown in FIGS. 7A, 7B and 8 can be used in place of the homodyne detectors in a manner similar to that described above in connection with FIGS. 4, 7A, 7B and 8.

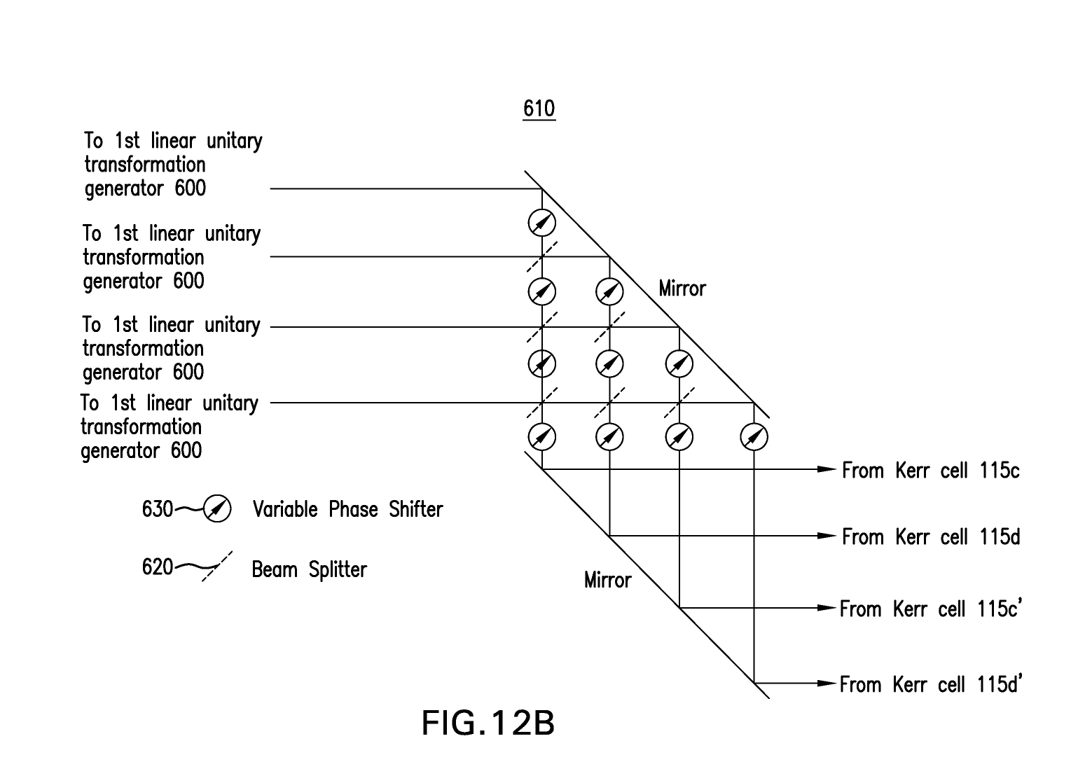

The linear unitary transformation generators 600/610 are preferably implemented using beam splitters and variable linear phase modulators, such as those described in Ref. [19]. An example of such a linear unitary transformation generator is shown in FIGS. 12A and 12B. FIG. 12A shows an example of linear unitary transformation generator 600 and FIG. 12B shows an example of linear unitary transformation generator 600. Both generators 600 and 610 follow the same principles of operation.

Namely, beam splitters 620 and variable phase generators 630 are arranged to provide a linear unitary transformation. The linear unitary transformation can be changed by adjusting the phase shift imparted by variable phase shifters 630, as described in Ref. [19]. The beam splitters 620 are suitably implemented with fused silica fibers, but any other type of beam splitter known in the art may be utilized. The variable phase shifters 630 are suitably implemented with a, electro-optic variable phase shifter, such as a lithium niobate waveguide phase modulator.

The linear unitary transformation generator 600 imparts a unitary linear transformation Û. The variable phase shifters 630 in the linear unitary transformation generator 610 are adjusted so as to impart the inverse transformation Û⁻¹ in order to regain the original set of M pairs of phase-entangled coherent states created by Alice.

The number and placement of beam splitters 620 and variable phase shifters 630 in the linear unitary transformation generators 600 and 610 are appropriate for the M=2 system (two pairs of phase-entangled coherent states) shown in FIG. 11. The number and placement of beam splitters 620 and variable phase shifters 630 will be different for systems that utilize other values of M.

The foregoing embodiments and advantages are merely exemplary, and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. Various changes may be made without departing from the spirit and scope of the invention, as defined in the following claims (after the Appendix below).

### APPENDIX

1. B. T. Kirby, J. D. Franson, Phys. Rev. A 87, 053822 (2013).
2. P. Hayden, D. Leung, P. W. Shor, A. Winter, Com. Math. Phys. 250, 371-391 (2004).
3. J. D. Franson, “Entangled Photon Holes”, Phys. Rev. Lett. 96, 090402 (2006).
4. T. B. Pittman and J. D. Franson, “Generation of Entangled Photon Holes using Quantum Interference”, Phys. Rev. A 74, 041801 (R) (2006).
5. J. D. Franson, “Sensitivity of Entangled Photon Holes to Loss and Amplification”, Phys. Rev. A 84, 043831 (2011).
6. W. J. Munro, K. Nemoto, and T. P. Spiller, New J. Phys. 7, 137 (2005).
7. B. C. Sanders, Phys. Rev. A 45, 6811 (1992).
8. C. C. Gerry, Phys. Rev. A 59, 4095 (1999); C. C. Gerry and R. Grobe, ibid. 75, 034303 (2007).
9. H. Jeong, M. S. Kim, T. C. Ralph, and B. S. Ham, Phys. Rev. A 70, 061801 (2004).
10. K. Nemoto and W. J. Munro, Phys. Rev. Lett. 93, 250502 (2004).
11. H. Jeong, Phys. Rev. A 72, 034305 (2005).
12. D. S. Simon, G. Jaeger, and A. V. Sergienko, Phys. Rev. A. 89, 012315 (2014).
13. J. D. Franson, Phys. Rev. Lett. 62, 2205 (1989).
14. J. F. Clauser, M. A. Home, A. Shimony, and R. A. Holt, Phys. Rev. Lett. 23, 880 (1969).
15. A. Mann, B. C. Sanders, and W. J. Munro, Phys. Rev. A 51, 989 (1995).
16. S. Izumi, M. Takeoka, M. Fujiwara, N. Dalla Pozza, A. Assalini, K. Erna, and M. Sasaki, Phys. Rev. A 86, 042328 (2012).
17. M. O. Scully and M. S. Zubairy, Quantum Optics (Cambridge University Press, Cambridge, England, 2006).
18. M. Akiba, K. Tsujino, and M. Sasaki, Opt. Lett. 35, 2621 (2010).
19. M. Reck, A. Zeilinger, H. J. Bernstein, and P. Bertani, Physical Review Letters, 73(1):58-61 (1994).

What is claimed is:

1. A quantum key distribution system, comprising:
a phase-entangled coherent state source for generating first and second phase-entangled coherent optical beams;
a first single photon interferometer located at a first location, wherein the first single photon interferometer comprises a first Kerr cell positioned in one path of the first single photon interferometer for receiving the first phase-entangled coherent optical beam;
a second single photon interferometer located at a second location, wherein the first second photon interferometer comprises a second Kerr cell positioned in one path of the second single photon interferometer for receiving the second phase-entangled coherent optical beam; and
a state discrimination system positioned to receive the first and second phase-entangled coherent optical beams after they have passed through the first and second Kerr cells, respectively.
